(19) United States
(12) Patent Application Publication
(10) Pub. No.: US 2010/0067802 A1
(43) Pub. Date: Mar. 18, 2010

(54) ESTIMATING A LOCATION OF AN OBJECT IN AN IMAGE

(76) Inventors: Yu Huang, Plainsboro, NJ (US); Joan Llach, Princeton, NJ (US)

Correspondence Address: Robert D. Shedd, Patent Operations;THOMSON Licensing LLC, P.O. Box 5312, Princeton, NJ, 08543-5312, US

(21) Appl. No.: 12/312,743

(22) PCT Filed: Nov. 30, 2007
(86) PCT No.: PCT/US07/24686

§ 371 Date: May 22, 2009

Related U.S. Application Data
(60) Provisional application No. 60/872,145, filed on Dec. 1, 2006.
(60) Provisional application No. 60/872,146, filed on Dec. 1, 2006.
(60) Provisional application No. 60/885,780, filed on Jan. 19, 2007.

(51) Int. Cl. G06K 9/46

(52) U.S. Cl. 382/195

(57) ABSTRACT

An implementation provides a method for estimating a location for an object in a particular image of a sequence of images. The location is estimated using a particle-based framework, such as a particle filter. It is determined that the estimated location for the object in the particular image is occluded. A trajectory is estimated for the object based on one or more previous locations of the object in one or more previous images in the sequence of images. The estimated location of the object is changed based on the estimated trajectory.

### CROSS-REFERENCE TO RELATED APPLICATIONS

This application claims the benefit of each of the following three applications: (1) U.S. Provisional Application Ser. No. 60/872,145 titled “Cluttered Backgrounds and Object Tracking” and filed Dec. 1, 2006 (Attorney Docket PU060244), (2) U.S. Provisional Application Ser. No. 60/872,146 titled “Modeling for Object Tracking” and filed Dec. 1, 2006 (Attorney Docket PU060245), and (3) U.S. Provisional Application Ser. No. 60/885,780 titled “Object Tracking” and filed Jan. 19, 2007 (Attorney Docket PU070030). All three of these priority applications are hereby incorporated by reference in their entirety for all purposes.

### FIELD OF THE INVENTION

At least one implementation in this disclosure relates to dynamic state estimation.

### BACKGROUND OF THE INVENTION

A dynamic system refers to a system in which a state of the system changes over time. The state may be a set of arbitrarily chosen variables that characterize the system, but the state often includes variables of interest. For example, a dynamic system may be constructed to characterize a video, and the state may be chosen to be a position of an object in a frame of the video. For example, the video may depict a tennis match, and the state may be chosen to be the position of the ball. The system is dynamic because the position of the ball changes over time. Estimating the state of the system, that is, the position of the ball, in a new frame of the video is of interest.

### SUMMARY

According to a general aspect, a location is estimated for an object in a particular image of a sequence of images. The location is estimated using a particle-based framework. It is determined that the estimated location for the object in the particular image is occluded. A trajectory is estimated for the object based on one or more previous locations of the object in one or more previous images in the sequence of images. The estimated location of the object is changed based on the estimated trajectory.

The details of one or more implementations are set forth in the accompanying drawings and the description below. Even if described in one particular manner, it should be clear that implementations may be configured or embodied in various manners. For example, an implementation may be performed as a method, or embodied as an apparatus configured to perform a set of operations, or embodied as an apparatus storing instructions for performing a set of operations, or embodied in a signal. Other aspects and features will become apparent from the following detailed description considered in conjunction with the accompanying drawings and the claims.

### BRIEF DESCRIPTION OF THE DRAWINGS

FIG. 1 includes a block diagram of an implementation of a state estimator.

FIG. 2 includes a block diagram of an implementation of an apparatus for implementing the state estimator of FIG. 1.

FIG. 3 includes a block diagram of an implementation of a system for encoding data based on a state estimated by the state estimator of FIG. 1.

FIG. 4 includes a block diagram of an implementation of a system for processing data based on a state estimated by the state estimator of FIG. 1.

FIG. 5 includes a diagram that pictorially depicts various functions performed by an implementation of the state estimator of FIG. 1.

FIG. 6 includes a flow diagram of an implementation of a method for determining a location of an object in an image in a sequence of digital images.

FIG. 7 includes a flow diagram of an implementation of a process for implementing a particle filter.

FIG. 8 includes a flow diagram of an alternative process for implementing a particle filter.

FIG. 9 includes a flow diagram of an implementation of a process for implementing a dynamic model in the process of FIG. 8.

FIG. 10 includes a flow diagram of an implementation of a process for implementing a dynamic model including evaluating a motion estimate in a particle filter.

FIG. 11 includes a flow diagram of an implementation of a process for implementing a measurement model in a particle filter.

FIG. 12 includes a diagram that pictorially depicts an example of a projected trajectory with occluded object locations.

FIG. 13 includes a flow diagram of an implementation of a process for determining whether to update a template after estimating a state using a particle filter.

FIG. 14 includes a flow diagram of an implementation of a process for determining whether to update a template and refining object position after estimating a state using a particle filter.

FIG. 15 includes a diagram that pictorially depicts an implementation of a method of refining estimated position of an object relative to a projected trajectory.

FIG. 16 includes a flow diagram of an implementation of a process for estimating location of an object.

FIG. 17 includes a flow diagram of an implementation of a process for selecting location estimates.

FIG. 18 includes a flow diagram of an implementation of a process for determining a position of a particle in a particle filter.

FIG. 19 includes a flow diagram of an implementation of a process for determining whether to update a template.

FIG. 20 includes a flow diagram of an implementation of a process for detecting occlusion of a particle in a particle filter.

FIG. 21 includes a flow diagram of an implementation of a process for estimating a state based on particles output by a particle filter.

FIG. 22 includes a flow diagram of an implementation of a process for changing an estimated position of an object.

FIG. 23 includes a flow diagram of an implementation of a process for determining an object location.

### DETAILED DESCRIPTION

One or more embodiments provide a method of dynamic state estimation. One or more embodiments provide a method of estimating dynamic states. An example of an application in which dynamic state estimation is used is in predicting the movement of a feature in video between frames. An example of video is compressed video, which may be compressed, by way of example, in the MPEG-2 format. In compressed video, only a subset of the frames typically contain complete information as to the image associated with the frames. Such frames containing complete information are called I-frames in the MPEG-2 format. Most frames only provide information indicating differences between the frame and one or more nearby frames, such as nearby I-frames. In the MPEG-2 format, such frames are termed P-frames and B-frames. It is a challenge to include sufficient information to predict the progress of a feature in video while still maintaining data compression.

An example of a feature in video is a ball in a sporting event. Examples include tennis balls, soccer balls, and basketballs. An example of an application in which the method is used is in predicting the location of a ball between frames in a multi-frame video. A ball may be a relatively small object, such as occupying less than about 30 pixels. A further example of a feature is a player or a referee in a sporting event.

A challenge to tracking motion of an object between frames in video is occlusion of the object in one or more frames. Occlusion may be in the form of the object being hidden behind a feature in the foreground. This is referred to as “real occlusion”. For example, in a tennis match, a tennis ball may pass behind a player. Such occlusion may be referred to in various manners, such as, for example, the object being hidden, blocked, or covered. In another example, occlusion may be in the form of a background which makes determination of the position of the object difficult or impossible. This is referred to as “virtual occlusion”. For example, a tennis ball may pass in front of a cluttered background, such as a crowd which includes numerous objects of approximately the same size and color as the tennis ball, so that selection of the ball from the other objects is difficult or impossible. In another example, a ball may pass in front of a field of the same color as the ball, so that location of the ball is impossible or difficult to determine. Occlusion, including clutter, make it difficult to form an accurate likelihood estimation of particles in a particle filter. Occlusion, including clutter, often results in ambiguity in object tracking.

These problems are often greater for small objects, or for fast moving objects. This is because, for example, the locations of a small object in successive pictures (for example, frames) in a video often do not overlap one another. When the locations do not overlap, the object itself does not overlap, meaning that the object has moved at least its own width in the time interval between the two successive pictures. The lack of overlap often makes it more difficult to find the object in the next picture, or to have a high confidence that the object has been found.

Ambiguity in object tracking is not limited to small objects. For example, a cluttered background may include features similar to an object. In that event, regardless of object size, ambiguity in tracking may result.

Determination of whether an object is occluded may also be challenging. For example, one known method of determining object occlusion is an inlier/outlier ratio. With small objects and/or a cluttered background, the inlier/outlier ratio may be difficult to determine.

An implementation addresses these challenges by forming a metric surface in a particle-based framework. Another implementation addresses these challenges by employing and evaluating motion estimates in a particle-based framework. Another implementation addresses these challenges by employing multiple hypotheses in likelihood estimation.

In a particle-based framework, a Monte Carlo simulation is typically conducted over numerous particles. The particles may represent, for example, different possible locations of an object in a frame. A particular particle may be selected based on the likelihood determined in accordance with a Monte Carlo simulation. A particle filter is an exemplary particle-based framework. In a particle filter, numerous particles are generated, representing possible states, which may correspond to possible locations of an object in an image. A likelihood, also referred to as a weight, is associated with each particle in the particle filter. In a particle filter, particles having a low likelihood or low weight are typically eliminated in one or more resampling steps. A state representing an outcome of a particle filter may be a weighted average of particles, for example.

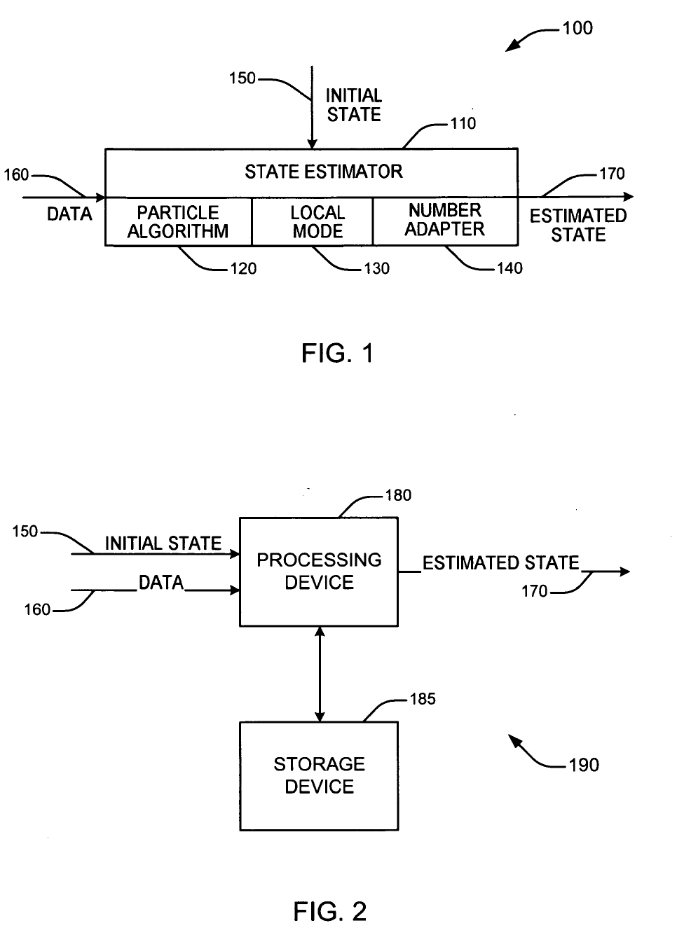

Referring to FIG. 1, in one implementation a system 100 includes a state estimator 110 that may be implemented, for example, on a computer. The state estimator 110 includes a particle algorithm module 120, a local-mode module 130, and a number adapter module 140. The particle algorithm module 120 performs a particle-based algorithm, such as, for example, a particle filter (PF), for estimating states of a dynamic system. The local-mode module 130 applies a local-mode seeking mechanism, such as, for example, by performing a mean-shift analysis on the particles of a PF. The number adapter module 140 modifies the number of particles used in the particle-based algorithm, such as, for example, by applying a Kullback-Leibler distance (KLD) sampling process to the particles of a PF. In an implementation, the particle filter can adaptively sample depending on the size of the state space where the particles are found. For example, if the particles are all found in a small part of the state space, a smaller number of particles may be sampled. If the state space is large, or the state uncertainty is high, a larger number of particles may be sampled. The modules 120-140 may be, for example, implemented separately or integrated into a single algorithm.

The state estimator 110 accesses as input both an initial state 150 and a data input 160, and provides as output an estimated state 170. The initial state 150 may be determined, for example, by an initial-state detector or by a manual process. More specific examples are provided by considering a system for which the state is the location of an object in an image in a sequence of digital images, such as a frame of a video. In such a system, the initial object location may be determined, for example, by an automated object detection process using edge detection and template comparison, or manually by a user viewing the video. The data input 160 may be, for example, a sequence of video pictures. The estimated state 170 may be, for example, an estimate of the position of a ball in a particular video picture.

In FIG. 2, an exemplary apparatus 190 for implementing the state estimator 110 of FIG. 1 is shown. The apparatus 190 includes a processing device 180 that receives initial state 150 and data input 160, and provides as output an estimated state 170. The processing device 180 accesses a storage device 185, which may perform storing data relating to a particular image in a sequence of digital images.

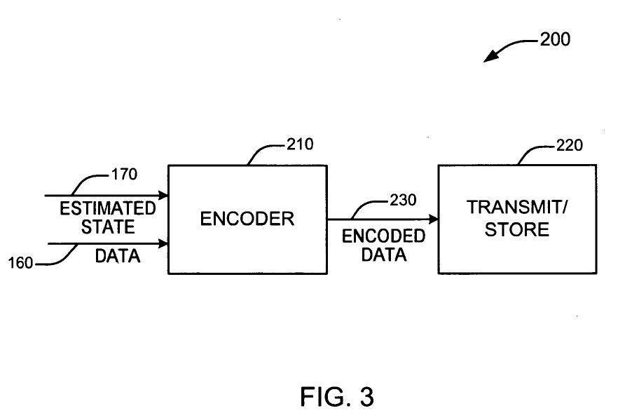

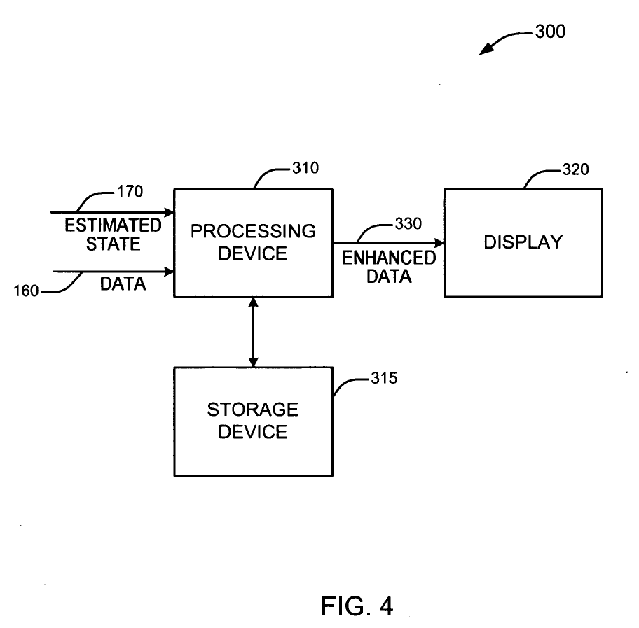

The estimated state 170 may be used for a variety of purposes. To provide further context, several applications are described using FIGS. 3 and 4.

Referring to FIG. 3, in one implementation a system 200 includes an encoder 210 coupled to a transmit/store device 220. The encoder 210 and the transmit/store device 220 may be implemented, for example, on a computer or a communications encoder. The encoder 210 accesses the estimated state 170 provided by the state estimator 110 of the system 100 in FIG. 1, and accesses the data input 160 used by the state estimator 110. The encoder 210 encodes the data input 160 according to one or more of a variety of coding algorithms, and provides an encoded data output 230 to the transmit/store device 220.

Further, the encoder 210 uses the estimated state 170 to differentially encode different portions of the data input 160. For example, if the state represents the position of an object in a video, the encoder 210 may encode a portion of the video corresponding to the estimated position using a first coding algorithm, and may encode another portion of the video not corresponding to the estimated position using a second coding algorithm. The first algorithm may, for example, provide more coding redundancy than the second coding algorithm, so that the estimated position of the object (and hopefully the object itself) will be expected to be reproduced with greater detail and resolution than other portions of the video.

Thus, for example, a generally low-resolution transmission may provide greater resolution for the object that is being tracked, allowing, for example, a user to view a golf ball in a golf match with greater ease. One such implementation allows a user to view the golf match on a mobile device over a low bandwidth (low data rate) link. The mobile device may be, for example, a cell phone or a personal digital assistant. The data rate is kept low by encoding the video of the golf match at a low data rate but using additional bits, compared to other portions of the images, to encode the golf ball.

The transmit/store device 220 may include one or more of a storage device or a transmission device. Accordingly, the transmit/store device 220 accesses the encoded data 230 and either transmits the data 230 or stores the data 230.

Referring to FIG. 4, in one implementation a system 300 includes a processing device 310 coupled to a local storage device 315 and coupled to a display 320. The processing device 310 accesses the estimated state 170 provided by the state estimator 110 of the system 100 in FIG. 1, and accesses the data input 160 used by the state estimator 110. The processing device 310 uses the estimated state 170 to enhance the data input 160 and provides an enhanced data output 330. The processing device 310 may cause data, including the estimated state, the data input, and elements thereof to be stored in the local storage device 315, and may retrieve such data from the local storage device 315. The display 320 accesses the enhanced data output 330 and displays the enhanced data on the display 320.

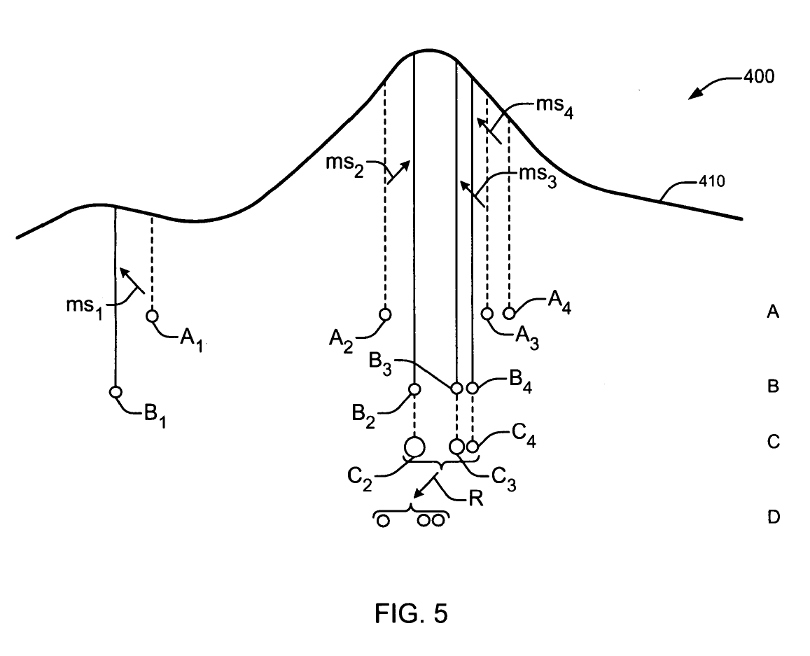

Referring to FIG. 5, a diagram 400 includes a probability distribution function 410 for a state of a dynamic system. The diagram 400 pictorially depicts various functions performed by an implementation of the state estimator 110. The diagram 400 represents one or more functions at each of levels A, B, C, and D.

The level A depicts the generation of four particles A1, A2, A3, and A4 by a PF. For convenience, separate vertical dashed lines indicate the position of the probability distribution function 410 above each of the four particles A1, A2, A3, and A4.

The level B depicts the shifting of the four particles A1-A4 to corresponding particles B1-B4 by a local-mode seeking algorithm based on a mean-shift analysis. For convenience, solid vertical lines indicate the position of the probability distribution function 410 above each of the four particles B1, B2, B3, and B4. The shift of each of the particles A1-A4 is graphically shown by corresponding arrows MS1-MS4, which indicate the particle movement from positions indicated by the particles A1-A4 to positions indicated by the particles B1-B4, respectively.

The level C depicts weighted particles C2-C4, which have the same positions as the particles B2-B4, respectively. The particles C2-C4 have varying sizes indicating a weighting that has been determined for the particles B2-B4 in the PF. The level C also reflects a reduction in the number of particles, according to a sampling process, such as a KLD sampling process, in which particle B1 has been discarded.

The level D depicts three new particles generated during a resampling process. The number of particles generated in the level D is the same as the number of particles in the level C, as indicated by an arrow R (R stands for resampling).

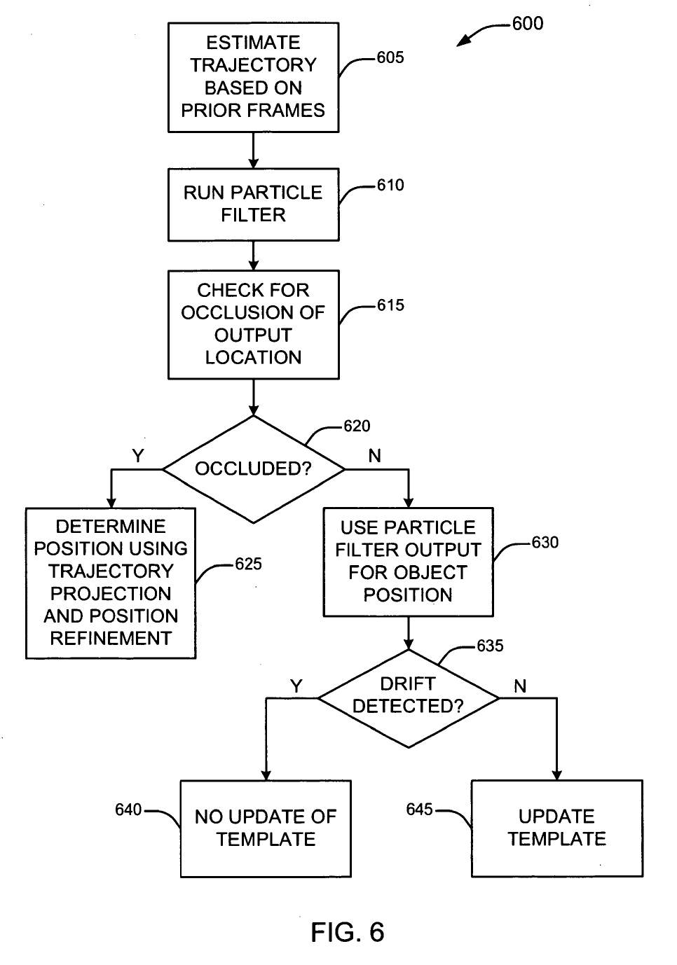

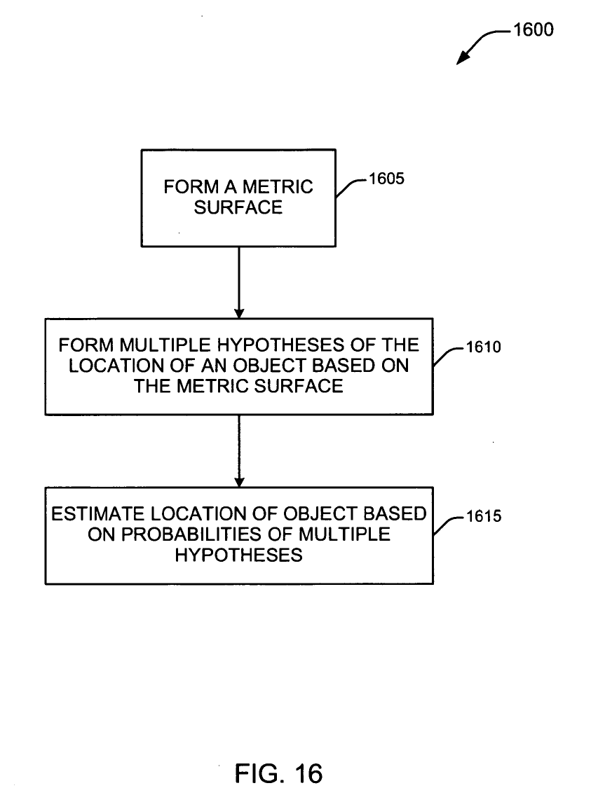

Referring now to FIG. 6, a high-level process flow 600 of a method for determining a location of an object in an image in a sequence of digital images is illustrated. A trajectory of the object may be estimated based on location information from prior frames 605. Trajectory estimation is known to those of skill in the art. A particle filter may be run 610. Various implementations of particle filters are described below. The location of the object predicted by an output of the particle filter may be checked for occlusion 615. Implementations of methods of checking for occlusion are explained hereinbelow. If occlusion is found 620, then a position may be determined using trajectory projection and interpolation 625. Implementations of position determination are explained below with respect to FIG. 16, for example. If occlusion is not found, then the particle filter output is used for determining particle position 630. If occlusion is not found, then the template is checked for drift 635. Drift refers to a change in the template, such as may occur, for example, if the object is getting further away or closer, or changing color. If drifting above a threshold is found 635, then an object template is not updated 640. This may be helpful, for example, because large drift values may indicate a partial occlusion. Updating the template based on a partial occlusion could cause a poor template to be used. Otherwise, if drifting is not above the threshold, then a template may be updated 645. When small changes occur (small drift values), there is typically more reliability or confidence that the changes are true changes to the object and not changes caused by, for example, occlusion.

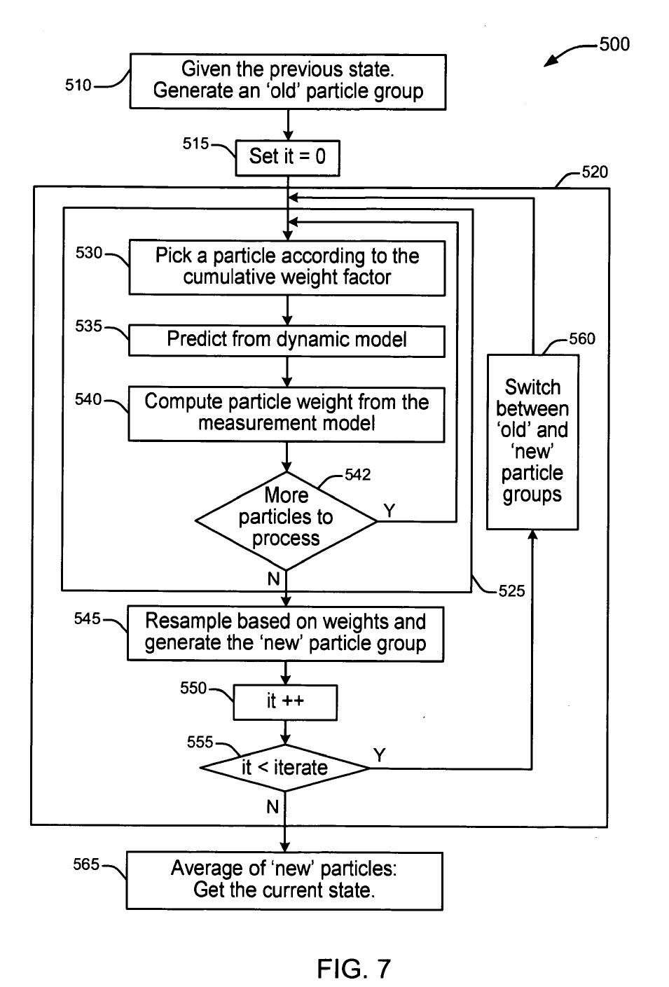

Referring now to FIG. 7, a process 500 of implementing a particle filter will be discussed. The process 500 includes accessing an initial set of particles and cumulative weight factors from a previous state 510. Cumulative weight factors may be generated from a set of particle weights and typically allow faster processing. Note that the first time through the process 500, the previous state will be the initial state and the initial set of particles and weights (cumulative weight factors) will need to be generated. The initial state may be provided, for example, as the initial state 150 (of FIG. 1).

Referring again to FIG. 7, a loop control variable “it” is initialized 515 and a loop 520 is executed repeatedly before determining the current state. The loop 520 uses the loop control variable “it”, and executes “iterate” number of times. Within the loop 520, each particle in the initial set of particles is treated separately in a loop 525. In one implementation, the PF is applied to video of a tennis match for tracking a tennis ball, and the loop 520 is performed a predetermined number of times (the value of the loop iteration variable “iterate”) for every new frame. Each iteration of the loop 520 is expected to improve the position of the particles, so that when the position of the tennis ball is estimated for each frame, the estimation is presumed to be based on good particles.

The loop 525 includes selecting a particle based on a cumulative weight factor 530. This is a method for selecting the remaining particle location with the largest weight, as is known. Note that many particles may be at the same location, in which case it is typically only necessary to perform the loop 525 once for each location. The loop 525 then includes updating the particle by predicting a new position in the state space for the selected particle 535. The prediction uses the dynamic model of the PF. This step will be explained in greater detail below.

The dynamic model characterizes the object state's change between frames. For example, a motion model, or motion estimation, which reflects the kinematics of the object, may be employed. In one implementation, a fixed constant velocity model with fixed noise variance may be fitted to object positions in past frames.

The loop 525 then includes determining the updated particle's weight using the measurement model of the PF 540. Determining the weight involves, as is known, analyzing the observed/measured data (for example, the video data in the current frame). Continuing the tennis match implementation, data from the current frame, at the location indicated by the particle, is compared to data from the tennis ball's last location. The comparison may involve, for example, analyzing color histograms or performing edge detection. The weight determined for the particle is based on a result of the comparison. The operation 540 also includes determining the cumulative weight factor for the particle position.

The loop 525 then includes determining if more particles are to be processed 542. If more particles are to be processed, the loop 525 is repeated and the process 500 jumps to the operation 530. After performing the loop 525 for every particle in the initial (or “old”) particle set, a complete set of updated particles has been generated.

The loop 520 then includes generating a “new” particle set and new cumulative weight factors using a resampling algorithm 545. The resampling algorithm is based on the weights of the particles, thus focusing on particles with larger weights. The resampling algorithm produces a set of particles that each have the same individual weight, but certain locations typically have many particles positioned at those locations. Thus, the particle locations typically have different cumulative weight factors.

Resampling typically also helps to reduce the degeneracy problem that is common in PFs. There are several ways to resample, such as multinomial, residual, stratified, and systematic resampling. One implementation uses residual resampling because residual resampling is not sensitive to particle order.

The loop 520 continues by incrementing the loop control variable “it” 550 and comparing “it” with the iteration variable “iterate” 555. If another iteration through the loop 520 is needed, then the new particle set and its cumulative weight factors are made available 560.

After performing the loop 520 “iterate” number of times, the particle set is expected to be a “good” particle set, and the current state is determined 565. The new state is determined, as is known, by averaging the particles in the new particle set.

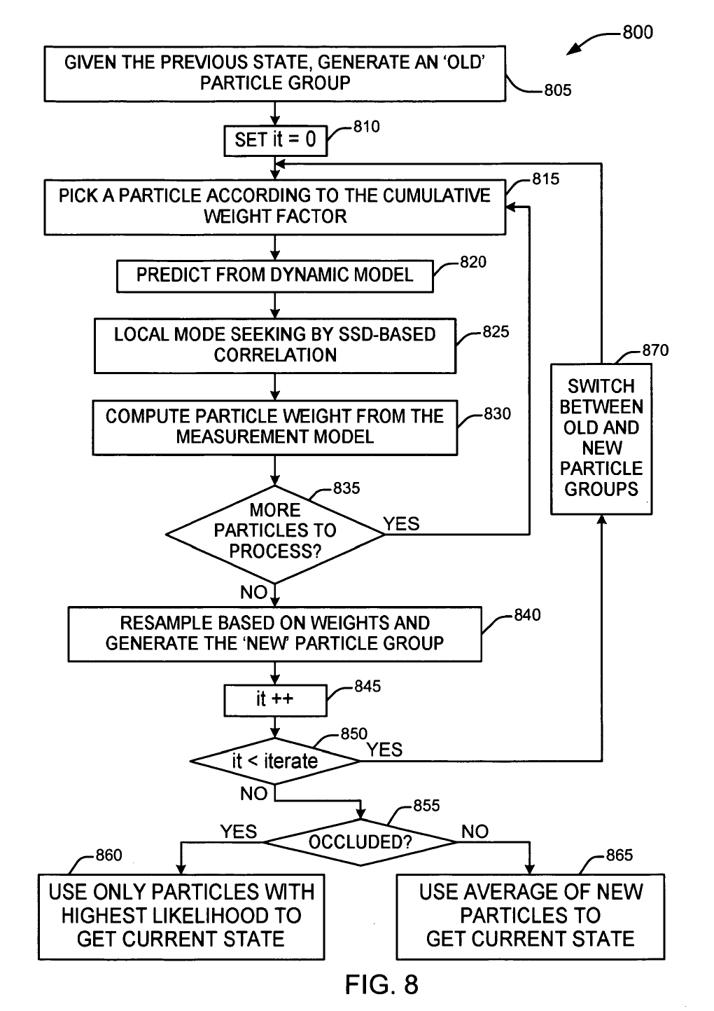

Referring now to FIG. 8, another implementation of a process flow including a particle filter will be explained. The overall process flow is similar to the process flow described above with reference to FIG. 7, and elements common to FIG. 7 and FIG. 8 will not be described here in detail. The process 800 includes accessing an initial set of particles and cumulative weight factors from a previous state 805. A loop control variable “it” is initialized 810 and a loop is executed repeatedly before determining the current state. In the loop, a particle is selected according to a cumulative weight factor. The process then updates the particle by predicting a new position in the state space for the selected particle 820. The prediction uses the dynamic model of the PF.

The local mode of the particle is then sought using a correlation surface, such as an SSD-based correlation surface 825. A local minimum of the SSD is identified, and then the position of the particle is changed to the identified local minimum of the SSD. Other implementations, using an appropriate surface, identify a local maximum of the surface and change the position of the particle to the identified local maximum. The weight of the moved particle is then determined 830 from the measurement model. By way of example, a correlation surface and multiple hypotheses may be employed in computing the weight, as described below. If there are more particles to process 835, then the loop returns to picking a particle. If all particles have been processed, then the particles are resampled based on the new weights, and a new particle group is generated 840. The loop control variable “it” is incremented 845. If “it” is less than the iteration threshold 850, then the process switches to the old particle group 870, and repeats the process.

If the final iteration has been completed, a further step is conducted prior to obtaining the current state. An occlusion indicator for the object in the prior frame is checked 855. If the occlusion indicator shows occlusion in the prior frame, then a subset of particles is considered for selection of the current state 860. The subset of particles is selected by the particles having the highest weight. In an embodiment, the subset of particles is the particle having the highest weight. If more than one particle has the same, highest, weight, then all of the particles having the highest weight are included in the subset. The state of the particle may be deemed a detection state. The selection of a subset of particles is made because occlusion negatively affects the reliability of particles having lower weights. If the occlusion indicator shows that there is no occlusion in the prior frame, then an average of the new particle group may be used to determine the current state 865. In this case, the state is a tracking state. It will be appreciated that the average may be weighted in accordance with particle weights. It will also be appreciated that other statistical measures than an average (for example, a mean) may be employed to determine the current state.

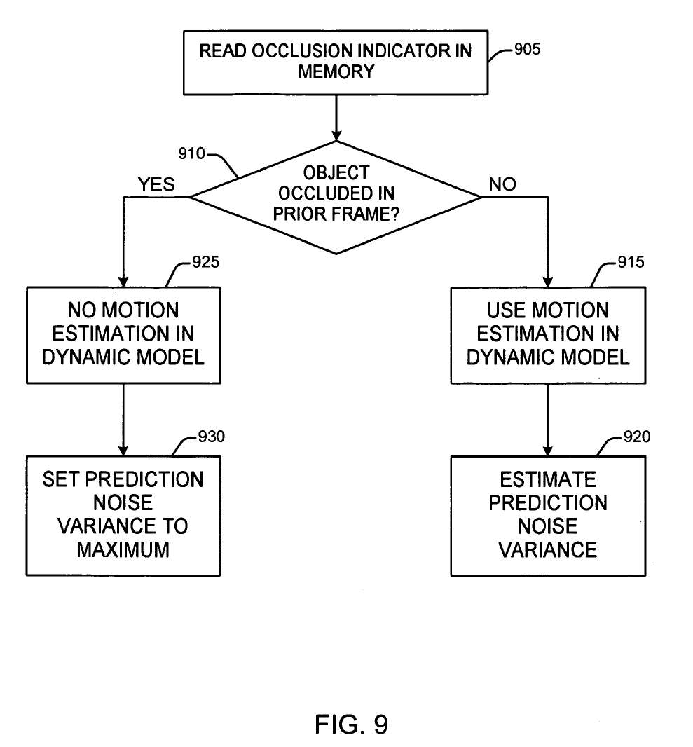

Referring to FIG. 9, an implementation 900 of the dynamic model (820 of FIG. 8) is explained. In the dynamic model, motion information from prior frames may be employed. By using motion information from prior frames, the particles will be more likely to be closer to the actual position of the object, thereby increasing efficiency, accuracy, or both. In the dynamic model, as an alternative, a random walk may be employed in generating particles.

The dynamic model may employ a state space model for small object tracking. A state space model for small object tracking, for an image, in a sequence of digital images, at time t, may be formulated as:

Xₜ₊₁=f(Xₜ,μₜ),

Zₜ=g(Xₜ,ξₜ),

where x, represents the object state vector, z, is the observation vector, f and g are two vector-valued functions (the dynamic model and the observation model, respectively), and μₜ and ξₜ represent the process or dynamic noise, and observation noise respectively. In motion estimation, the object state vector is defined as X=(x, y), where (x, y) are the coordinates of the center of an object window. The estimated motion is preferably obtained from data from prior frames, and may be estimated from the optic flow equation. The estimated motion for an object in an image at time t may be Vₜ. The dynamic model may be represented as:

Xₜ₊₁=Xₜ+Vₜ+μₜ,

The variance of prediction noise μₜ may be estimated from motion data, such as from an error measure of motion estimation. A motion residual from the optic flow equation may be employed. Alternatively, the variance of prediction noise may be an intensity-based criterion, such as a motion compensation residual; however, a variance based on motion data may be preferable to a variance based on intensity data.

For each particle, a stored occlusion indicator is read, indicated by block 905. The occlusion indicator indicates whether the object was determined to be occluded in the prior frame. If reading the indicator 910 indicates that the object was occluded, then no motion estimation is employed in the dynamic model 915. It will be appreciated that occlusion reduces the accuracy of motion estimation. A value of prediction noise variance for the particle may be set to a maximum 920. By contrast, if reading the occlusion indicator shows that there is no occlusion in the prior frame, then the process uses motion estimation 925 in generating particles. A prediction noise variance method may be estimated 930, such as from motion data.

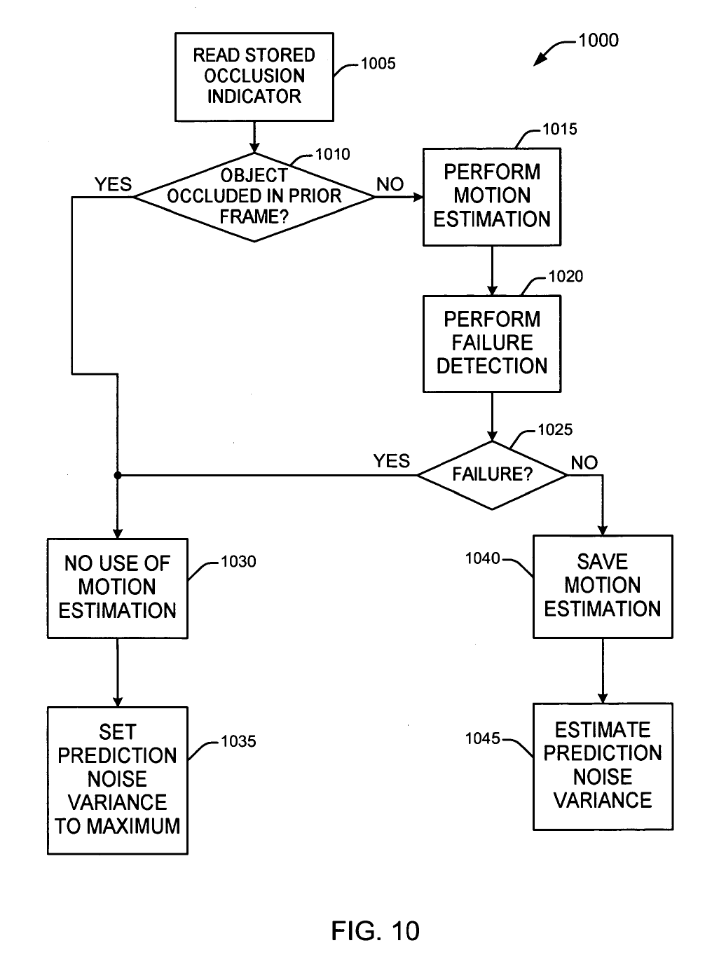

Referring now to FIG. 10, an implementation of a process flow 1000 performed with respect to each particle in a dynamic model within a particle filter, before sampling, is illustrated. Intially, an occlusion indicator in memory is checked 1005. The occlusion indicator may indicate occlusion of the object in the prior frame. If occlusion of the object in the prior frame is found 1010, then motion estimation is not used for the dynamic model 1030, and the prediction noise variance for the particle is set to a maximum 1035. If the stored occlusion indicator does not indicate occlusion of the object in the prior frame, then motion estimation is performed 1015.

Motion estimation may be based on using positions of the object in past frames in the optic flow equation. The optic flow equation is known to those of skill in the art. After motion estimation, failure detection 1020 is performed on the particle location resulting from motion estimation. Various metrics may be used for failure detection. In one implementation, an average of an absolute intensity difference between the object image as reflected in the template and an image patch centered around the particle location derived from motion estimation may be calculated. If the average exceeds a selected threshold, then the motion estimation is deemed to have failed 1025, and no use is made of the motion estimation results 1030 for the particle. The prediction noise variance for the particle may be set to its maximum 1035. If the motion estimation is deemed not to have failed, then the motion estimation result is saved 1040 as the prediction for that particle. Prediction noise variance may then be estimated 1045. For example, the optic flow equation may be used to provide a motion residual value which may be used as the prediction noise variance.

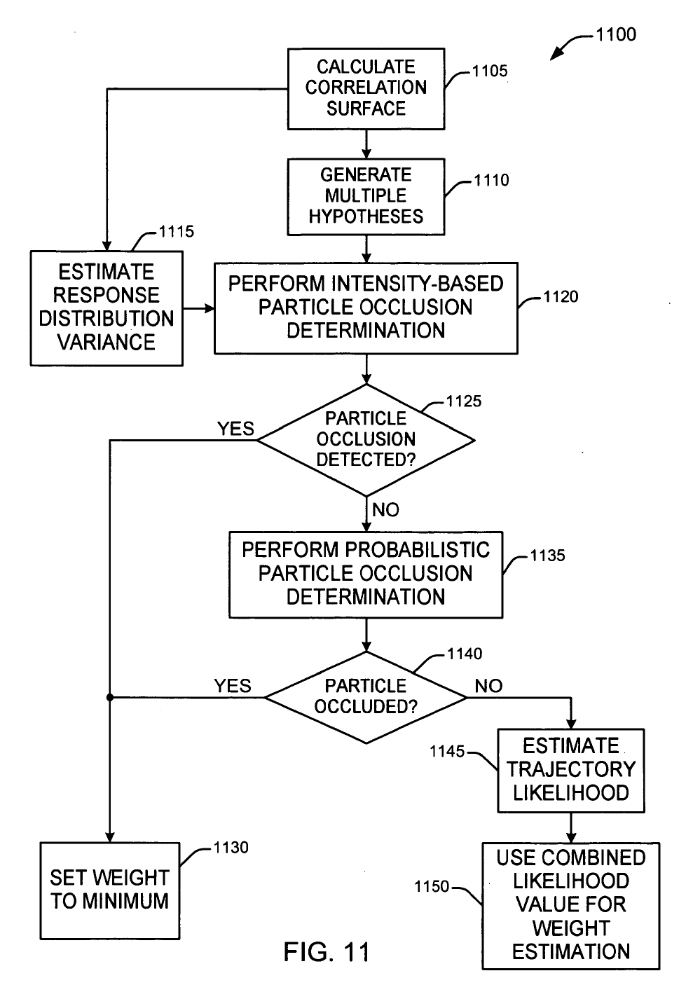

Referring now to FIG. 11, an implementation of computing particle weight using the measurement model will be discussed. Method 1100 is performed with respect to each particle. Method 1100 commences with calculation of a metric surface, which may be a correlation surface, as indicated by block 1105. A metric surface may be employed to measure the difference between a template, or target model, and the current candidate particle. In an implementation, a metric surface may be generated as follows.

A metric for the difference between the template and the candidate particle may be a metric surface, such as a correlation surface. In one implementation, a sum-of-squared differences (SSD) surface is used that has the following formula:

$${Z}_{t} = {arg min}_{{X}_{t} ∈ Neib} {\sum }_{χ ∈ W}^{ } {[ T ( χ ) - I ( χ + {X}_{t} ) ]}^{2}$$

Here, W represents the object window, Neib is a small neighborhood around the object center Xₜ. T is the object template and I is the image in the current frame. In a small object with a cluttered background, this surface may not represent an accurate estimate of a likelihood. A further exemplary correlation surface may be:

$$r ( {X}_{t} ) = {\sum }_{χ ∈ W} {[ T ( χ ) - I ( χ + {X}_{t} ) ]}^{2} , {X}_{t} ∈ Neib .$$

The size of the correlation surface can be varied. Depending on the quality of the motion estimation, which may be determined as the inverse of the variance, the size of the correlation surface can be varied. In general, with higher quality of motion estimation, the correlation surface can be made smaller.

Multiple hypotheses for the motion of the particle may be generated 1110 based on the metric surface. Candidate hypotheses are associated with a local minimum or maximum of the correlation surface. For example, if J candidates from the SSD correlation surface are identified in the support area Neib, J+1 hypotheses can be defined as:

H₀={cⱼ=C:j=1, . . . , J},

Hⱼ={cⱼ=T,cᵢ=C:i=1, . . . , J, i≠j}, j=1, . . . , J,

where cⱼ=T means the jth candidate is associated with the true match, cⱼ=C otherwise. Hypothesis H₀ means that none of the candidates is associated with the true match. In this implementation, clutter is assumed to be uniformly distributed over the neighborhood Neib and otherwise the true match-oriented measurement is a Gaussian distribution.

With those assumptions, the likelihood associated with each particle may be expressed as:

$$P ( {z}_{t} \vert {X}_{t} ) = {q}_{0} U ( \cdot ) + {C}_{N} {\sum }_{j = 1}^{J} {q}_{j} N ( {r}_{t} , {σ}_{t} ) , \\ such that$$

$${q}_{0} + {\sum }_{j = 1 \text{\textasciitilde} J}^{ } {q}_{j} = 1 ,$$

where C_{N} is a normalization factor, q₀ is the prior probability of hypothesis H₀ and qⱼ is the probability for hypothesis Hⱼ, j=1, . . . , J. Accordingly, the likelihood measurement using the SSD is refined taking into account clutter by use of multiple hypotheses.

A response distribution variance estimation, 1115 is also made.

A determination may be made as to whether the particle is occluded. Particle occlusion determination may be based on an intensity-based assessment 1120, such as an SAD (sum of average differences) metric, that may be used to compare an object template and the candidate particle. Such assessments are known to those of skill in the art. Based on the SAD, a determination may be made as to particles that are very likely to be occluded. Intensity-based assessments of occlusion are relatively computationally inexpensive, but in a cluttered background may not be highly accurate. By setting a high threshold, certain particles may be determined to be occluded using an intensity based assessment 1125, and their weights set to a minimum 1130. In such cases, there may be a high confidence that occlusion has occurred. For example, a threshold may be selected such that the case of real occlusion with no clutter is identified, but other cases of occlusion are not identified.

If the intensity-based assessment does not indicate occlusion, then a probabilistic particle occlusion determination may be made 1135. The probabilistic particle occlusion detection may be based on generated multiple hypotheses and the response distribution variance estimation. A distribution may be generated to approximate the SSD surface and occlusion is determined (or not) based on that distribution using an eigenvalue of a covariance matrix, as discussed below.

A response distribution may be defined to approximate a probability distribution on the true match location. In other words, a probability D that the particle location is a true match location may be:

D(Xₜ)=exp(−ρ·r(Xₜ)),

Where ρ is a normalization factor. The normalization factor may be chosen to ensure a selected maximum response, such as a maximum of 0.95. A covariance matrix Rₜ associated with the measurement Zₜ is constructed from the response distribution as

$${R}_{t} = [ \begin{matrix}{\sum }_{( x , y ) ∈ Neib}^{ } {D}_{t} ( x , y ) {( x - {x}_{p} )}^{2} & {\sum }_{( x , y ) ∈ Neib}^{ } {D}_{t} ( x , y ) ( x - {x}_{p} ) ( y - {y}_{p} ) \\ {\sum }_{( x , y ) ∈ Neib}^{ } {D}_{t} ( x , y ) ( x - {x}_{p} ) ( y - {y}_{p} ) & {\sum }_{( x , y ) ∈ Neib}^{ } {D}_{t} ( x , y ) {( y - {y}_{p} )}^{2}\end{matrix} ] \text{/} {N}_{R} ,$$

where (xₚ,yₚ) is the window center of each candidate and

$${N}_{R} = {\sum }_{( x , y ) ∈ Neib}^{ } {D}_{t} ( x , y )$$

is the covariance normalization factor. The reciprocals of the eigenvalues of Rₜ may be used as a confidence metric associated with the candidate. In an implementation, the maximum eigenvalue of Rₜ may be compared to a threshold; if the maximum eigenvalue exceeds the threshold, occlusion is detected. In response to a detection of occlusion 1140, the particle is given the smallest available weight 1130, which will generally be a non-zero weight. If occlusion is not detected, a likelihood may be calculated.

In an implementation, if occlusion is detected, rather than setting the weight or likelihood to the smallest value, the particle likelihood may be generated based on intensity and motion, but with no consideration to trajectory. On the other hand, if occlusion is not detected, likelihood for the particle may be generated based on intensity, for example.

In an implementation, weights to be assigned to particles may be based at least in part on consideration of at least a portion of the image near the position indicated by the particle. For example, for a given particle, a patch, such as a 5×5 block of pixels from an object template is compared to the position indicated by the particle and to other areas. The comparison may be based on a sum of absolute differences (SAD) matrix or a histogram, particularly for larger objects. The object template is thus compared to the image around the position indicated by the particle. If the off-position comparisons are sufficiently different, then the weight assigned to the particle may be higher. On the other hand, if the area indicated by the particle is more similar to the other areas, then the weight of the particle may be correspondingly decreased. A correlation surface, such as an SSD, may be generated that models the off-position areas, based on the comparisons.

If the result of the determination is that the particle is not occluded, then an estimate may be made of the trajectory likelihood 1145. For the estimation of the particle weight, a weighted determination may be employed 1150.

The weighted determination may include one or more of intensity likelihood (for example, template matching), motion likelihood (for example, a linear extrapolation of past object locations), and trajectory likelihood. These factors may be employed to determine a likelihood or weight of each particle in the particle filter. In an implementation, an assumption may be made that camera motion does not affect trajectory smoothness, and therefore does not affect the trajectory likelihood. In an implementation, a particle likelihood may be defined as:

P(zₜ|Xₜ)=P(Zₜ^{int}|Xₜ)P(Zₜ^{mot}|Xₜ)P(Zₜ^{trj}|Xₜ),

where Zₜ={Zₜ^{int},Zₜ^{mot},Zₜ^{trj}}, in which an intensity measurement, which may be SSD surface-based, is Zₜ^{int}, a motion likelihood is given by Zₜ^{mot} and a trajectory likelihood is given by Zₜ^{trj}. These three values may be assumed to be independent. The calculation of the intensity likelihood P(Zₜ^{int}|Xₜ) is known to those of ordinary skill in the art.

The motion likelihood may be calculated based on the difference between the particle's position change (speed) and the average change in position of the object over recent frames:

d²ₘₒₜ=(|Δxₜ|− Δ̅x̅)²+(|Δyₜ|− Δ̅y̅)², t>1

where (Δxₜ,Δyₜ) is the particle's position change with respect to (xᵣ₋₁,yᵢ₋₁), and ( Δ̅x̅, Δ̅y̅) is the average object speed over a selection of recent frames, i.e.,

$$\overline{Δ x} = {\sum }_{s = 1}^{t - 1} \vert {x}_{s} - {x}_{s - 1} \vert f ( t - 1 ) , \overline{Δ y} = {\sum }_{s = 1}^{t - 1} \vert {y}_{s} - {y}_{s - 1} \vert f ( t - 1 ) .$$

Hence the motion likelihood may be calculated based on a distance dₘₒₜ (for example, the Euclidian distance) between the position predicted by the dynamic model and the particle position as

$$P ( {Z}_{t}^{mot} \vert {X}_{t} ) = \frac{1}{\sqrt{2 π} {σ}_{mot}} exp ( - \frac{- {d}_{mot}^{2}}{2 {σ}_{mot}^{2}} ) .$$

In an implementation, a trajectory smoothness likelihood may be estimated from the particle's closeness to a trajectory that is calculated based on a sequence of positions of the object in recent frames of the video. The trajectory function may be represented as y=f(x), the parametric form of which may be:

$$y = {\sum }_{i = 0}^{m} {a}_{i} {x}^{i} ,$$

Where aᵢ represents the polynomial coefficients and m is the order of the polynomial function (for example, m=2). In calculating the trajectory function, the formula may be modified. A first modification may involve disregarding or discounting object positions, if the object position is determined to correspond to an occluded state in the particular past frame. Second, a weighting factor, which may be called a forgotten factor, is calculated to weight the particle's closeness to the trajectory. The more frames in which the object is occluded, the less reliable is the estimated trajectory, and hence the larger the forgotten factor.

The “forgotten factor” is simply a confidence value. A user may assign a value to the forgotten factor based on a variety of considerations. Such considerations may include, for example, whether the object is occluded in a previous picture, the number of previous pictures in which the object is occluded, the number of consecutive previous pictures in which the object is occluded, or the reliability of non-occluded data. Each picture may have a different forgotten factor.

In an exemplary implementation, the trajectory smoothness likelihood may be given as:

$$P ( {Z}_{t}^{trj} \vert {X}_{t} ) = \frac{1}{\sqrt{2 π} {σ}_{trj}} exp ( - \frac{- {[ {d}_{trj} / {( {λ}_{f} )}^{t\_ocl} ]}^{2}}{2 {σ}_{trj}^{2}} )$$

Where the closeness value is dₜᵣⱼ=|y−f(x)|, λ_{f} is the manually selected forgotten ratio, 0<λ_{f}<1 (for instance, λ_{f}=0.9), and t_ocl is the number of recent frames in which the object is occluded.

In an implementation, if a determination is made that the object is occluded in the preceding frame, then a particle likelihood may be determined based on an intensity likelihood and a trajectory likelihood, but not taking into account a motion likelihood. If a determination is made that the object is not occluded in the preceding frame, then a particle likelihood may be determined based on an intensity likelihood and a motion likelihood, but not taking into account a trajectory likelihood. This may be advantageous because when the object's location is known in the prior frame, there is typically relatively little benefit to providing trajectory constraints. Moreover, incorporating trajectory constraints may violate the temporal Markov chain assumption, i.e., the use of trajectory constraints renders the following state dependent on the state in frames other than the immediately preceding frame. If the object is occluded, or a determination has been made that motion estimation will be below a threshold, then there is typically no benefit to including motion likelihood in the particle likelihood determination. In this implementation, the particle likelihood may be expressed as:

P(Zₜ|Xₜ)=P(Zₜ^{int}|Xₜ)P(Zₜ^{mot}|Xₜ)^{O}^{_{t−1}} P(Zₜ^{trj}|Xₜ)^{1-O}^{_{t−1}}

where Oₜ=0 if the object is occluded, and 1 otherwise.

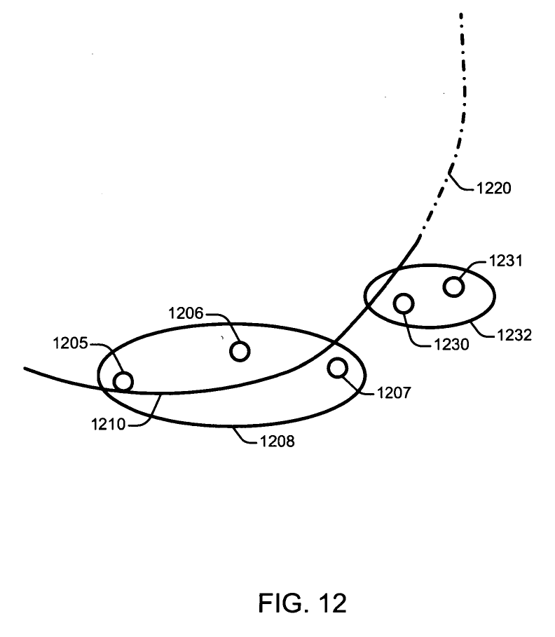

Referring now to FIG. 12, there is shown an illustration of an exemplary fitting of an object trajectory to object locations in frames of a video. Elements 1205, 1206, and 1207 represent locations of a small object in three frames of a video. Elements 1205, 1206, and 1207 are in a zone 1208 and are not occluded. Elements 1230 and 1231 represent locations of a small object in two frames of the video, after the frames represented by elements 1205, 1206, and 1207. Elements 1230 and 1231 are in zone 1232, and have been determined to be occluded, and thus there is a high level of uncertainty about the determined locations. Thus, in FIG. 12, t_ocl=2. An actual trajectory 1210 is shown, which is projected to a predicted trajectory 1220.

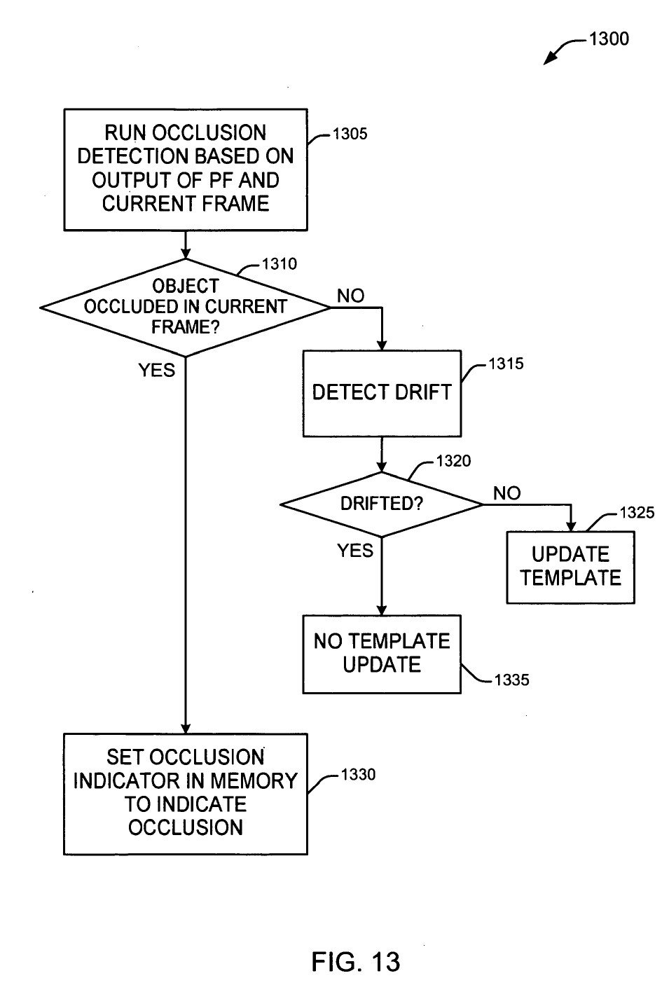

Referring now to FIG. 13, a process flow of an implementation of a template is illustrated. At the commencement of the process flow of FIG. 13, a new state of an object has been estimated, such as by a particle filter. The new estimated state corresponds, for example, to an estimated location of an object in a new frame. The process flow 1300 of FIG. 13 may be employed to determine whether to reuse an existing template in estimating the state for the next succeeding frame. As indicated by step 1305, occlusion detection is performed on the new estimated location of the object in the current frame. If occlusion is detected 1310, then an occlusion indicator is set in memory 1330. This indication may be employed in the particle filter for the following frame, for example. If occlusion is not detected, then the process flow proceeds to detecting drift 1315. In an implementation, drift may be in the form of a motion residual between the object's image in the new frame and the initial template. If drifting exceeds a threshold 1320, then the template is not updated 1335. If drifting does not exceed a threshold, then the template may be updated 1325, with an object window image from the current frame. Object motion parameters may also be updated.

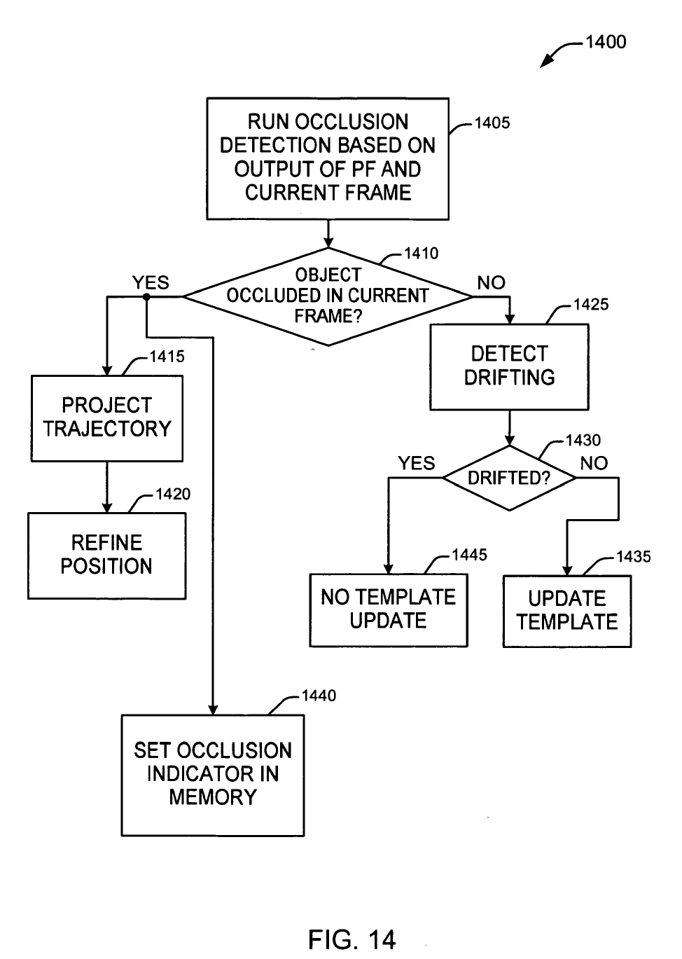

Referring now to FIG. 14, a flow diagram of an alternative implementation to the process 1300 for updating object templates and refining position estimates is illustrated. In process 1400, after determination of the current object state, occlusion detection for the determined object location and the current frame is performed 1405. If occlusion is detected 1410, then the estimated object position may be modified. Such modification may be useful because, for example, the occlusion may reduce the confidence that the determined object location is accurate. Thus, a refined position estimate may be useful. In one example, the determination of occlusion may be based on the existence of clutter, and the determined object location may actually be the location of some of the clutter.

The modification may be implemented using information related to trajectory smoothness. An object position may be projected on a determined trajectory 1415 using information from position data in prior frames. A straight line projection using constant velocity, for example, may be employed. The position may be refined 1420.

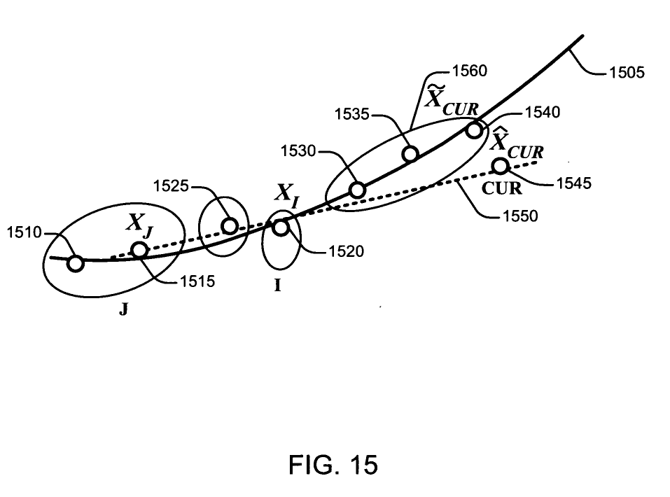

Referring to FIG. 15, an illustration is provided of a process of projecting an objection location on a trajectory and refining the location. A trajectory 1505 is shown. Position 1510 represents an object position in a prior frame. Data point 1515 represents position Xⱼ in a prior frame at time j. Data point 1520 represents a position X in a prior frame at time i. Data points 1510, 1515, and 1520 represent non-occluded object positions, and thus are relatively high quality data. Data points 1525, 1530, 1535, 1540 represent positions of the object in prior frames, but subject to occlusion. Accordingly, these data points may be disregarded or given a lower weight in trajectory calculations. Trajectory 1505 was previously developed based on fitting these data points, subject to weighting for occlusion of certain data points.

An initial calculation of the position of the object in the current frame, i.e., at time cur, may be calculated using a straight line and constant velocity, using the formula:

\hat{X}_{cur}−Xᵢ+(Xᵢ−Xⱼ)*(cur−i)/(i−j).

This is represented by a straight line projection 1550 (also referred to as a linear extrapolation) to obtain an initial estimated current frame location 1545 (also referred to as a linear location estimate). The initial estimated current frame location may then be projected on the calculated trajectory as \tilde{X}_{cur} (also referred to as a projection point), which is the point on the trajectory closest to \hat{X}_{cur}. The projection may use the formula:

\hat{X}_{cur}=(1−λ_{f}^{t}^{_{—}}^{ocl})\hat{X}_{cur}+\tilde{X}_{cur}*λ_{f}^{t}^{_{—}}^{ocl}.

where λ_{f} is the forgotten ratio, 0<λ_{f}<1 (for instance, λ_{f}=0.9), and t_ocl is the number of frames the object has been occluded since the last time it was visible. In an implementation, a projection may be a point on the trajectory interpolated between \hat{X}_{cur} and \tilde{X}_{cur}. Thus, the projection will be on a line between \hat{X}_{cur} and \tilde{X}_{cur}. In such an implementation, the projection may be represented as:

X_{cur}=(1−λ_{f}^{t}^{_{—}}^{ocl})\hat{X}_{cur}+\tilde{X}_{cur}*λ_{f}^{t}^{_{—}}^{ocl}.

In FIG. 15, the object was occluded at the two latest frames, as represented by positions 1530, 1535, t_ocl=2. The application of this formula generally moves the object location to a position interpolated between the trajectory and the straight line projection. As t_ocl becomes higher, the trajectory is less certain, and the location is closer to the straight line projection. In the example given by FIG. 15, the interpolated position 1540 is determined. The position 1540 is occluded, as it is within an occluded zone 1545.

Referring again to FIG. 14, the process flow when the result of checking for occlusion results in a finding of no occlusion will be explained. Drifting of the object template is determined 1425. Drifting of the template may be detected by applying motion estimation to both the current template and the initial template. The results are compared. If the difference between the two templates after application of motion estimation are above a threshold 1430, then drifting has occurred. In that case, then the prior template is not updated 1445, and a new template is obtained. If the difference is not above a threshold, then the template is updated 1435.

The process flow also includes updating of the occlusion indicator in memory 1440. The occlusion indicator for the prior frame will then be checked in the particle filter when estimating object position for the next frame.

Referring now to FIG. 16, a method 1600 includes forming a metric surface in a particle-based framework for tracking an object 1605, the metric surface relating to a particular image in a sequence of digital images. Multiple hypotheses are formed of a location of the object in the particular image based on the metric surface 1610. The location of the object is estimated based on the probabilities of the multiple hypotheses 1615.

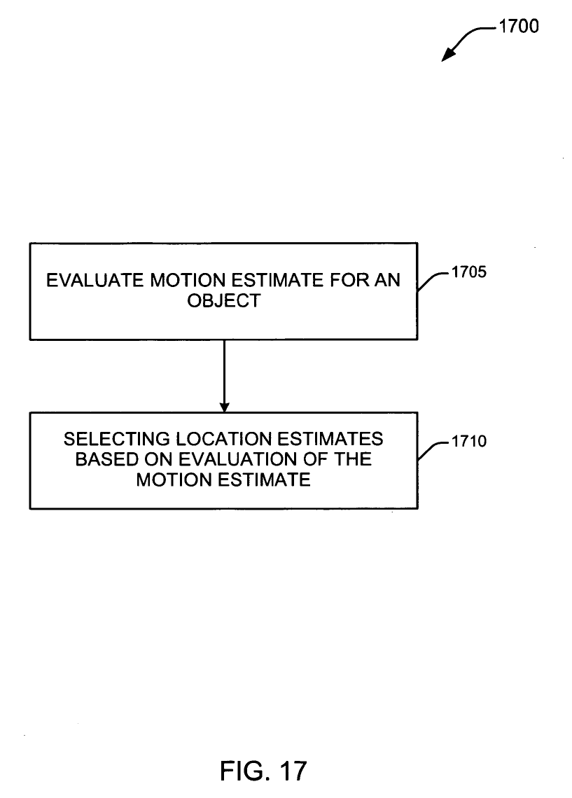

Referring now to FIG. 17, a method 1700 includes evaluating a motion estimate for an object in a particular image in a sequence of digital images 1705, the motion estimate being based on a previous image in the sequence. At least one location estimate is selected for the object based on a result of the evaluating 1710. The location estimate is part of a particle-based framework for tracking the object.

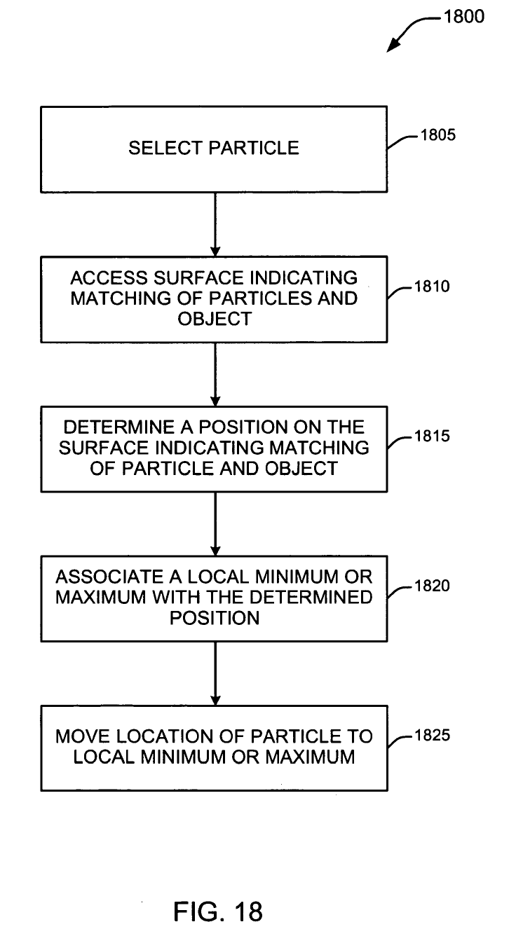

Referring now to FIG. 18, a method 1800 includes selecting a particle in a particle-based framework used to track an object between images in a sequence of digital images 1805, the particle having a location. The method 1800 includes accessing a surface that indicates the extent to which one or more particles match the object 1810. The method 1800 further includes determining a position on the surface 1815, the position being associated with the selected particle and indicating the extent to which the selected particle matches the object. The method 1800 includes associating a local minimum or maximum of the surface with the determined position 1820. The method 1800 also includes moving the location of the selected particle to correspond to the determined local minimum or maximum 1825.

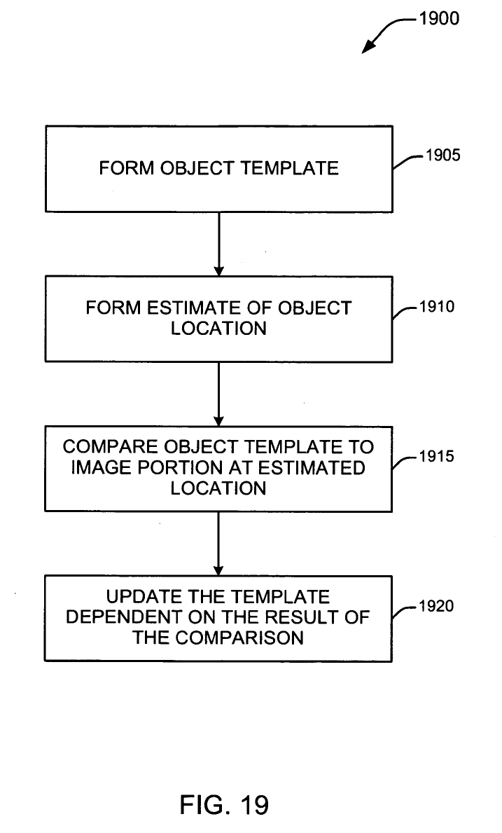

Referring now to FIG. 19, a method 1900 includes forming an object template 1905 for an object in a sequence of digital images. The method 1900 also includes forming an estimate of a location of the object 1910 in a particular image in the sequence, the estimate being formed using a particle-based framework. The object template is compared to a portion of the particular image at the estimated location 1915. It is determined whether to update the object template depending on the result of the comparing 1920.

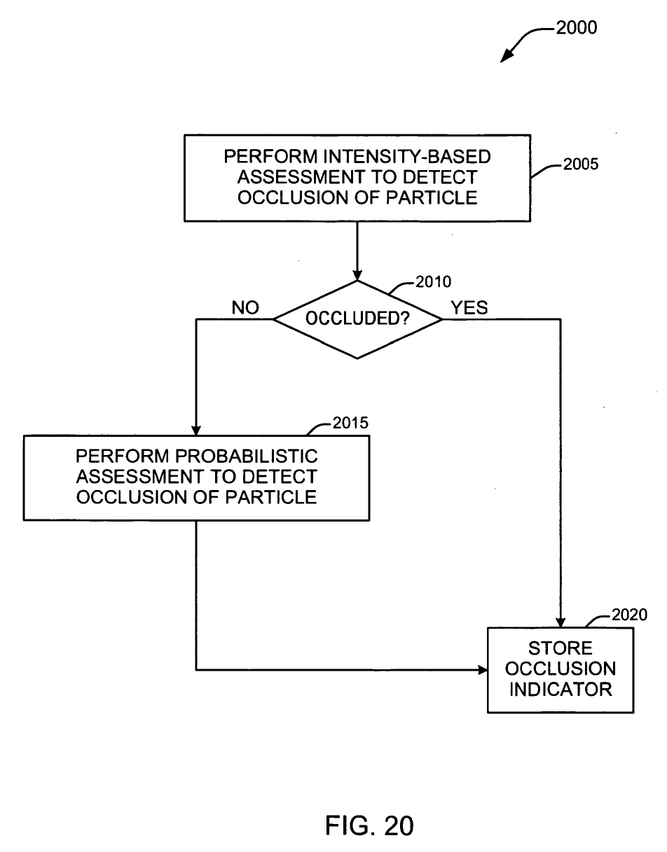

Referring now to FIG. 20, a method 2000 includes performing an assessment based on intensity to detect occlusion 2005 in a particle-based framework for tracking an object between images in a sequence of digital images. In an implementation, the assessment based on intensity may be based on data association. If occlusion is not detected, 2010, then a probabilistic assessment is performed to detect occlusion 2015. In an implementation, the probabilistic assessment may include the method described above based on a correlation surface. An indicator of the result of the process of detecting occlusion is optionally stored 2020.

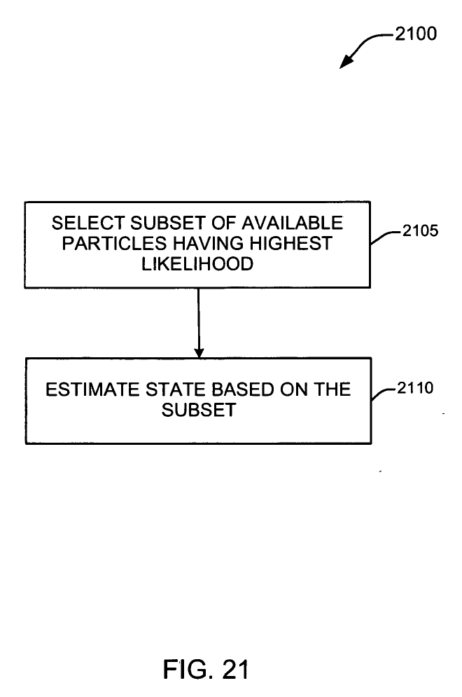

Referring now to FIG. 21, a method 2100 includes selecting a subset of available particles 2105 for tracking an object between images in a sequence of digital images. In one implementation, as shown in FIG. 21, the particle(s) having a highest likelihood are selected. A state is estimated based on the selected subset of particles 2110.

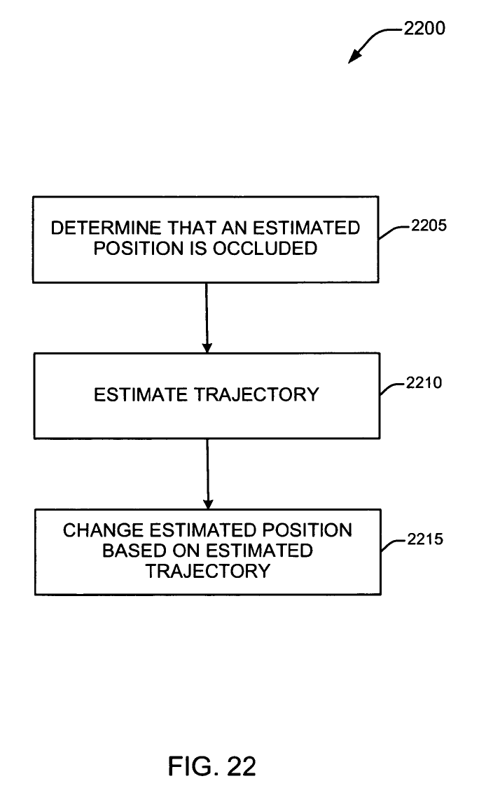

Referring now to FIG. 22, a method 2200 includes determining that an estimated position for an object in a particular frame in a sequence of digital images is occluded 2205. A trajectory is estimated for the object 2210. The estimated position is changed based on the estimated trajectory 2215.

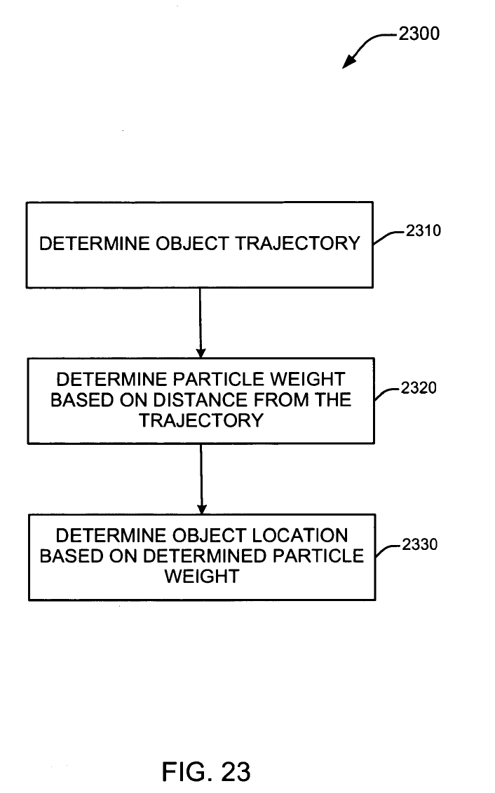

Referring now to FIG. 23, a method 2300 includes determining an object trajectory 2310. The object may be, for example, in a particular image in a sequence of digital images, and the trajectory may be based on one or more previous locations of the object in one or more previous images in the sequence. The method 2300 includes determining a particle weight based on distance from the particle to the trajectory 2320. The particle may be used, for example, in a particle-based framework for tracking the object. The method 2300 includes determining an object location based on the determined particle weight 2330. The location may be determined using, for example, a particle-based framework.

Implementations may produce, for example, a location estimate for an object. Such an estimate may be used in encoding a picture that includes the object, for example. The encoding may use, for example, MPEG-1, MPEG-2, MPEG-4, H.264, or other encoding techniques. The estimate, or the encoding, may be provided on, for example, a signal or a processor-readable medium. Implementations may also be adapted to non-object-tracking applications, or non-video applications. For example, a state may represent a feature other than an object location, and need not even relate to an object.

The implementations described herein may be implemented in, for example, a method or process, an apparatus, or a software program. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processing devices also include communication devices, such as, for example, computers, cell phones, portable/personal digital assistants (“PDAs”), and other devices that facilitate communication of information between end-users.

Implementations of the various processes and features described herein may be embodied in a variety of different equipment or applications, particularly, for example, equipment or applications associated with data encoding and decoding. Examples of equipment include video coders, video decoders, video codecs, web servers, set-top boxes, laptops, personal computers, cell phones, PDAs, and other communication devices. As should be clear, the equipment may be mobile and even installed in a mobile vehicle.

Additionally, the methods may be implemented by instructions being performed by a processor, and such instructions may be stored on a processor-readable medium such as, for example, an integrated circuit, a software carrier or other storage device such as, for example, a hard disk, a compact diskette, a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a computer readable medium having instructions for carrying out a process.

As should be evident to one of skill in the art, implementations may also produce a signal formatted to carry information that may be, for example, stored or transmitted. The information may include, for example, instructions for performing a method, or data produced by one of the described implementations. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application and are within the scope of the following claims.

1. A method comprising:
estimating a location for an object in a particular image of a sequence of images, the location being estimated using a particle-based framework;
determining that the estimated location for the object in the particular image is occluded;
estimating a trajectory for the object based on one or more previous locations of the object in one or more previous images in the sequence of images; and
changing the estimated location of the object based on the estimated trajectory.

2. The method of claim 1, further comprising:
determining an object portion of the particular image that includes the changed estimated location of the object;
determining a non-object portion of the image that is separate from the object portion; and
encoding the object portion and the non-object portion, such that the object portion is encoded with more coding redundancy than the non-object portion is encoded with.

3. The method of claim 1, wherein changing the estimated location comprises:
determining a linear location estimate based on a linear extrapolation of one or more previous locations of the object in one or more previous images in the sequence of images;
determining the changed estimated location based on the linear location estimate.

4. The method of claim 3, wherein determining the changed estimated location comprises:
determining a projection point on the estimated trajectory closest to the linear location estimate;
selecting a location on a line connecting the determined projection point and the linear location estimate, the location being selected based on a confidence value in the estimated trajectory.

5. The method of claim 4, wherein the confidence value is based on the number of consecutive previous images of the sequence in which the object has been occluded.

6. The method of claim 1, wherein the object is small enough such that the one or more previous locations of the object within an image do not overlap each other.

7. The method of claim 1, wherein the estimated trajectory is non-linear.

8. The method of claim 1, wherein the one or more previous locations of the object, which are used in estimating the trajectory, are non-occluded locations.

9. The method of claim 1, wherein the trajectory is estimated at least in part on a weighted occurrence of occlusion of the object in previous images in the sequence of images.

10. The method of claim 1, wherein an object location at an occlusion state in one of the previous images in the sequence of images is disregarded in estimating the trajectory.

11. The method of claim 1, wherein a reliability of an estimated trajectory is weighted by information relating to occlusion of an object in one or more previous images.

12. The method of claim 1, wherein the object has a size of less than about 30 pixels.

13. The method of claim 1, wherein the particle-based framework comprises a particle filter.

14. The method of claim 1, wherein the method is implemented in an encoder.

15. An apparatus comprising
a storage device for storing data relating to a particular image in a sequence of digital images; and
a processor for performing an intensity-based measure to detect occlusion in a particle-based framework for tracking an object in the sequence of digital images, and for performing, if occlusion is not detected in the step of performing an intensity-based measure, a probabilistic measure to detect occlusion in the particle-based framework.

16. The apparatus of claim 15, further comprising an encoder that includes the storage device and the processor.

17. A processor-readable medium having stored thereon a plurality of instructions for performing:
performing an assessment based on intensity to detect occlusion in a particle-based framework for tracking an object in a sequence of digital images; and
performing, if occlusion is not detected in the step of performing an assessment based on intensity, a probabilistic measure to detect occlusion in the particle-based framework.

18. An apparatus comprising:
means for storing data relating to a particular image in a sequence of digital images;
means for performing an assessment based on intensity to detect occlusion in a particle-based framework for tracking an object in a sequence of digital images; and
means for performing, if occlusion is not detected in the step of performing an assessment based on intensity, a probabilistic measure to detect occlusion in the particle-based framework.
